(19) United States
(12) Patent Application Publication
(10) Pub. No.: US 2019/0106343 A1
(43) Pub. Date: Apr. 11, 2019

(54) Stormwater Treatment System

(71) Applicant: Scott Horsley, Sandwich, MA (US)

(72) Inventor: Scott Horsley, Sandwich, MA (US)

(21) Appl. No.: 15/730,224

(22) Filed: Oct. 11, 2017

(51) Int. Cl. C02F 3/32; C02F 3/10; B01D 29/11

(52) U.S. Cl. CPC C02F 3/327; C02F 3/101; C02F 2103/001; C02F 3/109; B01D 29/114; C02F 3/103

(57) ABSTRACT

A linear stormwater treatment system is provided. The system utilizes plant growth in a medium to treat storm water and other runoff water. The medium is contained in a non-permeable container having an inlet for stormwater and an outlet for treated water. Root zone growth and the medium itself operate to filter and purify the stormwater, and contain the contaminants, providing controlled and environmentally friendly water treatment.

### BACKGROUND OF THE INVENTION

### Field of the Invention

The present invention relates generally to stormwater runoff treatment systems. More particularly the present invention relates to a linear stormwater treatment system which receives and treats stormwater runoff using plant root treatment, fluid recycle, and computerized flow control and operation.

### Description of Related Art

Stormwater runoff is water generated by rain contacting impervious and semi pervious land surfaces which contains significant amounts of contaminants. These contaminants are routinely transported to and discharged into downgradient wetlands, streams, lakes and coastal waters.

Stormwater pollutants include bacteria, viruses, metals, nutrients, oils and other organic compounds. Throughout the United States, stormwater pollution has resulted in the closure of shellfish beds, the eutrophication of waters, the pollution of drinking water supplies and impacts to ecological habitats.

Numerous studies performed by US EPA have demonstrated that the first flush of runoff contains the majority of the pollutants. This is because many of the contaminants are associated with sediment particles which accumulate on road and parking lot surfaces between storms and are transported during the beginning of the first significant precipitation event. Contaminants such as oils and other hydrocarbons also collect on impervious surfaces and are typically flushed during the beginning of a storm event.

Therefore, what is needed is a device that may effectively utilize plant root systems to treat stormwater runoff.

### SUMMARY OF THE INVENTION

The subject matter of this application may involve, in some cases, interrelated products, alternative solutions to a particular problem, and/or a plurality of different uses of a single system or article.

In one aspect, a linear stormwater treatment system is provided. The system utilizes a linear and elongate treatment chamber which treats the stormwater as it passes along the elongate length of the chamber. The chamber may have a semicircular cross section with the diameter side being open forming an open face, and being upwardly oriented. As such, this embodiment is formed as an approximately half-pipe shape. This semicircular shape uniquely provides structural support because of the strong half-cylindrical shape, and optimized planting and rooting depths for treatment. A quantity of medium, such as soil, gravel, or other granular material fills or at least partially fills the cavity of the chamber. A quantity of plant growth grows within the medium of the chamber such that root zones (roots) of the plants extend into the medium and in turn into the chamber cavity. A fluid inlet provides fluid flow into the chamber for treatment of stormwater. The inlet is configured to direct this inlet flow to the root zone of the plant growth in the medium. In an ideal configuration, the roots will be present throughout the cross section of the chamber and along the length of the chamber to provide maximum interaction of the stormwater with the roots and medium.

In another aspect, linear stormwater treatment system is provided. The system utilizes a linear and elongate treatment area that treats the storm water as it passes along the elongate length of the treatment area. The defined treatment area is bounded on the bottom and sides by a water-impermeable liner/boundary. A quantity of medium, such as soil, gravel, or other granular material fills or at least partially fills the treatment area. A quantity of plant growth grows within the medium of the treatment area such that root zones (roots) of the plants extend into the medium and in turn extend throughout the treatment area. An inlet provides fluid communication to the treatment area, while an outlet provides a fluid outlet from the treatment area.

The fluid inlet enters into a plurality of chambers which extend lengthwise through the defined treatment area, with each of the plurality of chambers having an arch-shaped cross section and defining an internal area. This arch-shaped structure provides structural support for the system, storage of water, and optimized planting and rooting depths for treatment (being shallow above the peak of the arch shape, deeper at the edges of the arch shaped chamber, and deepest where the chamber is not present). The chambers are oriented such that an open end of the arch shaped cross section is facing downward and is positioned near a bottom of the defined treatment area. A partially permeable layer covers the open area of the chamber to allow a controlled release of a fluid within the chamber. As configured, the stormwater fluid for treatment enters the system via the plurality of chambers and in turn through the partially permeable layer into the medium. The stormwater passes through the root zone, medium, and microorganisms there, which all the stormwater, before reaching the fluid outlet where it exits the treatment area.

### BRIEF DESCRIPTION OF THE DRAWINGS

FIG. 1 provides an elevation view of an embodiment of the present invention.

FIG. 2 provides a perspective view of an embodiment of the present invention positioned along a linear edge of a parking lot.

FIG. 3 provides a side cutaway view of another embodiment of the present invention.

FIG. 4 provides a side cutaway view of yet another embodiment of the present invention.

FIG. 5 provides a perspective view of another embodiment of the present invention.

FIG. 6 provides a perspective view of still another embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a stormwater treatment system which utilizes plant growth and root systems, along with other various treatment processes and system controls to process stormwater runoff. The system is generally linear which provides for enhanced processing control and predictability due to the progressive treatment from entry on one linear side to exit or recycle on the other linear side. Toxin and contaminant reduction along the linear path may decrease exponentially or linearly depending on toxin content and type, but can be more easily predicted and estimated in the linear flow structure of the present invention compared to the prior art non-linear structures.

The term “treatment” is defined herein to refer to any process which results in an outlet fluid having less dissolved or suspended material or components than when it enters the system at an inlet. The treatment contemplated herein may be achieved by any number of processes, including, but not limited to, mechanical settlement or separation, filtration, adhesion, absorption, adsorption, chemical reaction, uptake by the root systems of plants, microbial biochemical processing and the like.

Treatment is optimized by a variable planting depths with the deepest areas in the middle of the structure with smaller, shallower rooted plants along the margins.

The system typically includes a drain or drains which receives the stormwater runoff (although in some embodiments runoff may flow directly into the treatment system or to an inlet). A settling/pretreatment tank or structure may be connected to the drains to allow stormwater to flow into it. Sediment may settle out of suspension in the tank, facilitating the stormwater treatment. Fluid may exit the tank through an outlet, which may be controlled by a valve such as a computer-controlled valve, and into the treatment area of the system. The treatment portion is generally substantially linear (although in various embodiments may take other shapes). The treatment portion is formed by a chamber which is water-impermeable. Within the chamber is soil or other media, and plants grow in this soil/media such that roots of the plants extend downward into the media. As the stormwater flows through the treatment area, the soil/media and plant roots both serve to filter the stormwater, removing contaminants that are suspended and/or dissolved effectively.

In many embodiments, a computerized control system may be employed to control operation of the stormwater treatment system. The computer referenced herein may be any computerized controller as is well known to have elements such as a processor, a memory storing a programming, which may be reprogrammable or permanent, an input, an output, and the like. For example, an amount of fluid to be treated (measured by flow or volume sensors, or weather data—past and/or predicted, among other options) may determine a rate that fluid is released into the system, and may determine a rate of recycle of the fluid from entry to release. The weather data may be processed by a weather data module of the computerized controller, and may be received from an external source in communication with the computerized controller, or may be calculated by the weather data module of the computerized controller. In high flow conditions, fluid may need to be recycled more times to ensure complete processing. Or, in another embodiment of operation, practical considerations may necessitate that in high flow conditions, fluid is passed through the system at a high rate, which may result in less than complete processing that what might occur at a lower flow rate with longer residence time in the system (and/or recycle flow). While complete treatment is an optimal goal of the present invention, there may be certain conditions which necessitate more rapid but partial processing.

In one embodiment, the chamber may be a half-pipe design having a semicircular or arched cross section. This shape provides a number of advantages not present in the prior art. One advantage is that the semi-circular shape provides the shortest side to side perimeter (along the semicircular perimeter of the half-pipe cross section) and maximum volume. This ensures that as the plant roots grow, they are able to effectively fill in all around the soil/media. Further, the shape ensures that fluid that is passing through the system at various depths is also exposed to roots maximally. For example, because the depth is shallow at the lengthwise edges of the chamber, roots grow in this shallow portion, and extend laterally as well because they cannot extend downward. Other shapes encourage less uniform and less thorough root growth and thus less uniform contaminant treatment. Further, the downward sloping shape of the half-pipe directs fluid down towards a center bottom of the chamber. Generally, root growth also centers here because it is the deepest area and an area with the most plant growth. Accordingly the shape naturally guides the stormwater to be treated towards the best treatment area-which is the area with the most root growth.

In another embodiment, an inverted half pipe or arched shaped chamber, with the arch shape extending upwardly, may be used within a larger chamber as a fluid storage area that slowly releases fluid into the larger chamber. In such an embodiment, the inverted half pipe may be positioned to maximize root exposure time of the stormwater by releasing it at a bottom with an expected flow directing the stormwater upwardly and along the linear flow. This structure (and any other structure that releases stormwater at a bottom of the chamber and expects an upward flow path) effectively lengthens the fluid flow path and thus extends the exposure time by causing the fluid for treatment to move upward a height of the chamber, and along its length.

In further embodiments, a recycle flow function may recycle stormwater near to the outlet of the system back to the beginning for additional treatment. The recycle flow may work with any embodiment. Recycle flow may simply be a return flow to the inlet of the system or treatment area, or may include treatment or partial filtration of the recycling water during the return direction recycle flow.

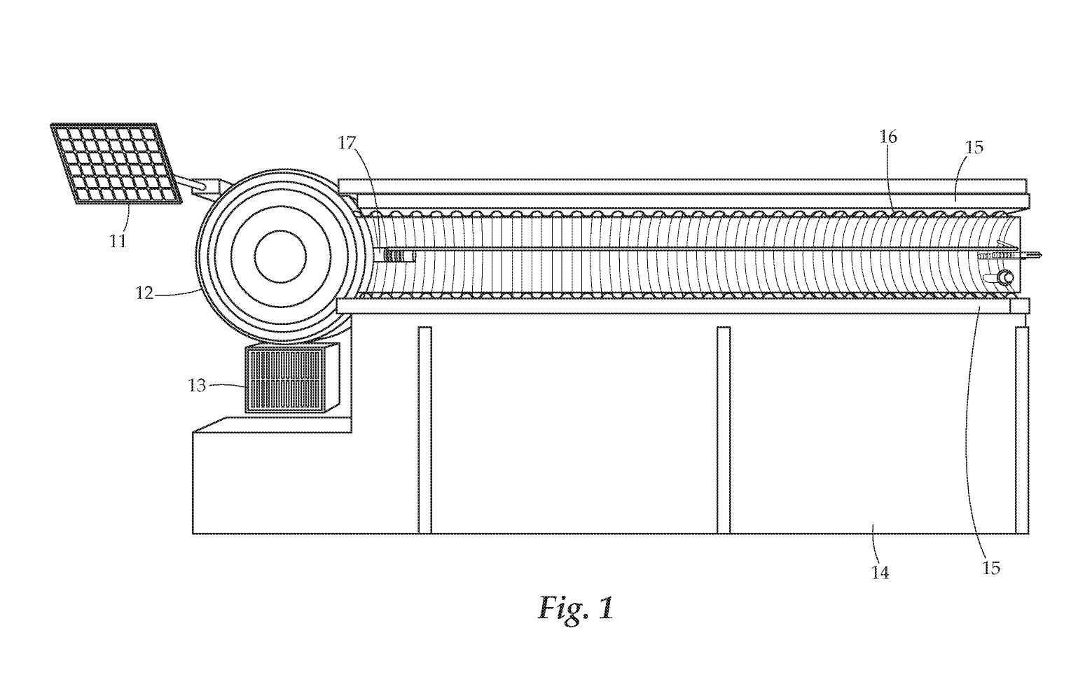

Turning now to FIG. 1 a linear stormwater treatment system of the present invention is provided. The system is positioned along a parking lot 14, which drains to drain 13, and has protective ridges 15 on both sides. Fluid from the drain 13 enters settling tank 12, which provides a storage area for stormwater and allows sediments, particulates, and the like to settle out via gravity. A computerized controller and power source 11 are connected to the system. The controller may engage with various aspects of the system such as sensor monitoring, weather tracking, fluid flow control, and the like. A series of valves may be connected to the computer controller which may open and close the valve or valves (not shown) to different degrees depending on conditions including sensed conditions, computerized programming, and received inputs to the controller.

Stormwater exits the fluid tank 12 into treatment area chamber 16 through flow path 17. This flow path may be a simple outlet pipe which empties into the early stages of the chamber (adjacent to the settling tank), or may be a pipe or other fluid conveyance that slowly releases fluid along the length of the chamber. Not shown in this view is the soil or other media that fills the chamber, and the plants planted therein and related roots. A recycle system may collect fluid at the exit end of the chamber and return it to the settling tank, or to the inlet end of the chamber, depending on embodiment. This recycle structure is shown in this view as an elongate pipe extending along the length of the chamber 16, though in other embodiments, the recycle structure may vary.

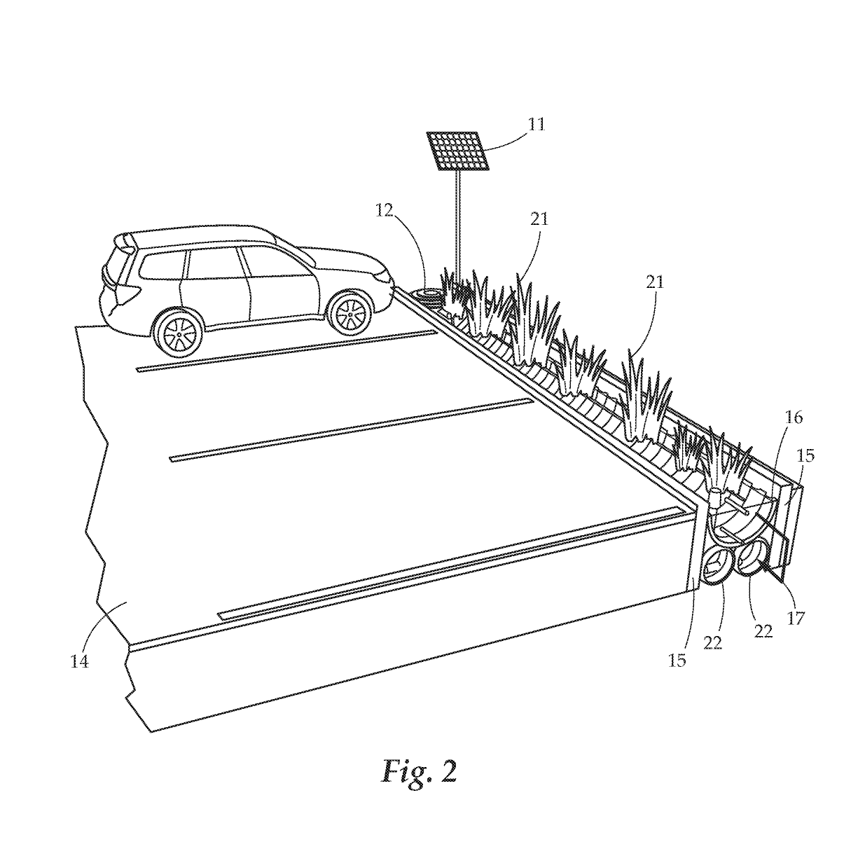

FIG. 2 shows another embodiment of the present invention in a perspective view. In this view, a similar arrangement to that of FIG. 1 is shown. However, in this embodiment, a recycle flow 17 exits the chamber 16 and is directed to flow pipes 22 underneath the system. These pipes may return the recycle flow 17 to the tank 12, or may be pumped up to the chamber 16 directly. In one embodiment, pipes 22 may be simple flow pipes. In another embodiment, pipes 22 may be filled or partially filled with a media such as soil, gravel, or other material that may serve as a secondary filter. Plants 12 grow in the media of the chamber 16 to capture and process contaminants, especially in the root zone (not shown) portion of the plants that grow in the media.

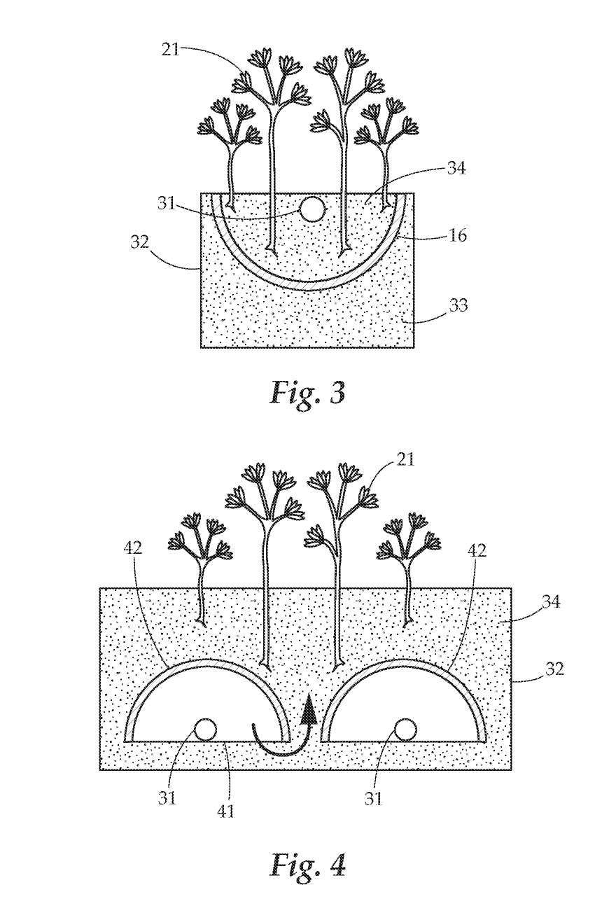

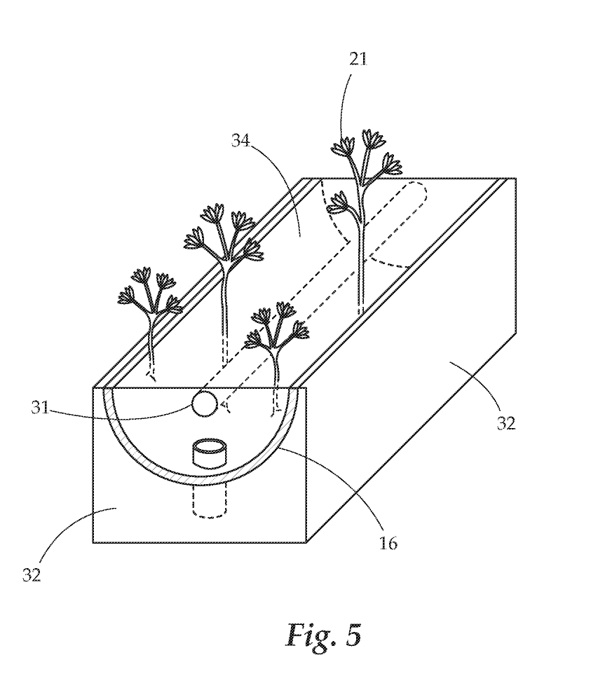

FIGS. 3 and 5 provide a cross sectional and perspective view of an embodiment of the present invention having a half pipe shaped chamber 16. In this view, fluid enters the system via element 31, which may be any structure capable of introducing stormwater fluid into the chamber 16. This may include a pipe opening, a porous pipe, a fluid-permeable or partially permeable layer, and the like. Fluid may enter at one end of the chamber 16, or across its length. In one embodiment, fluid may be released from only an area near a first lengthwise end of the chamber 16. In another embodiment, fluid may be released fairly evenly along the length of the chamber 16. A media 34, which may be soil, or any other material that plants may grow in, fills the chamber 16. Plants 21 extend into the media 34. As can be seen, plants closer to the center of the half-pipe chamber 16 have deeper roots, while the plants 21 closer to the edge have more shallow roots.

Accordingly, the shape of the chamber 16 ensures adequate root exposure along the width and also the height of the chamber 16. Fluid flowing through any area of the chamber will thus be exposed to the root zone, which captures a substantial amount of contaminants, and is critical for the stormwater treatment by the present invention. Below chamber 16 is gravel or other media 33. This media 33 provides support to the chamber 16, and in some embodiments, may be an area used for recycle flow or post-treatment flow. A water-impermeable liner 32 surrounds a defined treatment area of the system, ensuring that fluid is only allowed to enter via the inlet, and exit the system at a designated outlet area. In the embodiment of FIG. 5, fluid is released through 31 which in this embodiment is a permeable pipe to release stormwater along the center top portion of the chamber 16. As noted elsewhere, in other embodiments, fluid outlet 31 may be another structure such as a simple outlet pipe at an entry end of the treatment area, and the like. Also shown in FIG. 5 is an outlet for release of the treated stormwater, shown here as a pipe. It should be understood that any outlet structure may be used without straying from the scope of the present invention.

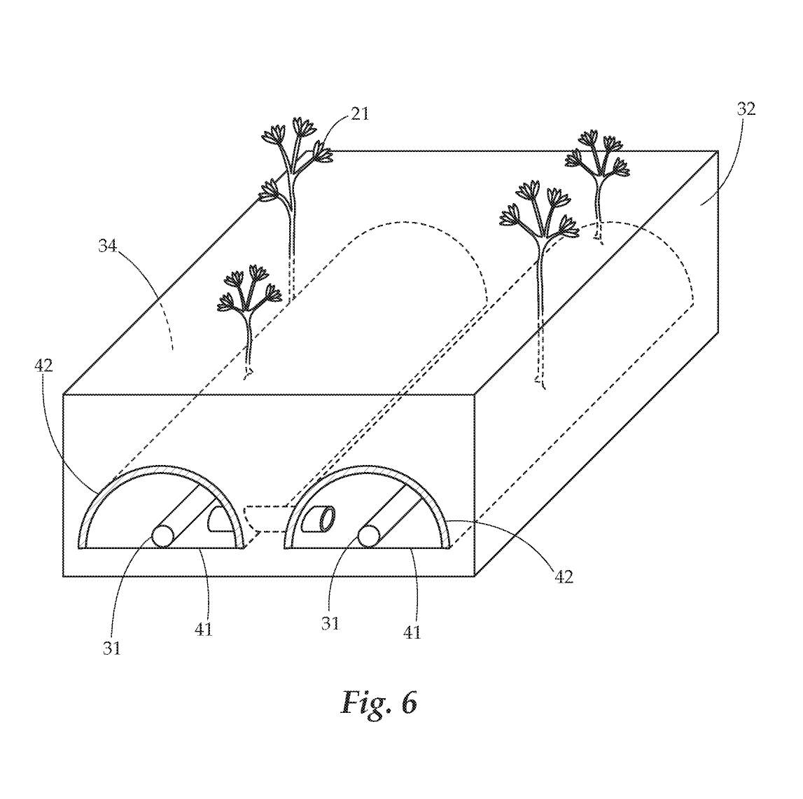

FIGS. 4 and 6 provide a cross sectional and perspective view of another embodiment of the present invention. In this view, the stormwater treatment system utilizes a liner 32, to define a treatment area containing a quantity of medium 34 and plant growth 21, especially root growth, to process stormwater. The system of this embodiment is longer than it is wide, and defines a largely linear orientation. Chambers 42, which are formed as half-pipe structures, are used as a preliminary holding tank for stormwater entering the system via inlet 31. A permeable, semipermeable, or perforated cover 41 allows fluid to slowly leave the chambers 42, either at one lengthwise end, or across the length, entering the media 34. One example of a cover 41 may be geotextile which prevents gravel, soil, or other medium infiltration into the chamber, but allows water to pass through. The chambers 42 are positioned at a bottom of the treatment area liner 32 which causes the fluid to exit near a bottom of the liner 32. This arrangement maximizes the exposure of the stormwater to the root area, allowing it to seep upward and lengthwise along the treatment area. An exemplary flow path of stormwater can be seen by the bold arrow of FIG. 4. In this upward flowing path, stormwater is guided into the substantial portion of roots in the root zone, maximizing exposure. In some embodiments, such as that shown in FIG. 6, the chambers 42 may be in fluid communication with each other, although that is not necessarily required. Also, in such an embodiment, the chambers 42 may serve as a fluid storage area, either instead of or in addition to the settling tank shown in, for example, FIG. 1.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

1. A linear stormwater treatment system comprising:
a chamber having a linear orientation, a semicircular cross-section, and having an open face with an upwardly facing orientation such that the diameter of the semicircular cross section is facing upward;
a quantity of medium within the chamber;
a quantity of plant growth within the chamber, a root zone of the plant growth being in the medium;
a fluid inlet configured to allow a fluid flow into and through the chamber, medium, and root zone.

2. The linear stormwater treatment system of claim 1 further comprising a settling tank having an outlet in fluid communication with the fluid inlet.

3. The linear stormwater treatment system of claim 1 wherein the system is positioned adjacent to a parking lot, a drain of the parking lot in communication with the fluid inlet.

4. The linear stormwater treatment system of claim 1 further comprising a recycle flow, such that at least a portion of a fluid exiting the chamber is returned to the fluid inlet.

5. The linear stormwater treatment system of claim 4 wherein the recycle flow is through a pipe, the pipe containing a treatment medium, the treatment medium providing further treatment to the recycle flow.

6. The linear stormwater treatment system of claim 1 further comprising a computer controlled valve positioned on the fluid inlet, the computer controlled valve configured to allow, prevent, and control a flow through the fluid inlet, depending on a valve position.

7. The linear stormwater treatment system of claim 6 wherein the computer controlled valve is in communication with a weather data module, the computer controlled valve configured to adjust the valve position based on the weather data.

8. The linear stormwater treatment system of claim 1 wherein the chamber is formed as a half-pipe.

9. The linear stormwater treatment system of claim 1 wherein the plants are positioned across the open face, such that a shallow root zone is formed at the outer edges of the chamber near a shallow area of the semicircular shape, and a deep root zone is formed at the central portion of the chamber near a deep area of the semicircular shape.

10. The linear stormwater treatment system of claim 1 wherein the fluid inlet is configured to evenly distribute fluid along a length of the chamber, the fluid inlet configured as a pipe extending along the length of the chamber and having a plurality of flow outlets into the chamber.

11. A linear stormwater treatment system comprising:
a defined treatment area having a water-impermeable boundary, and being at least partially filled with a medium, the treatment area having an inlet and an outlet;
a plurality of plant growth positioned within the medium, roots of the plant growth extending into the medium;
a plurality of chambers extending lengthwise through the defined treatment area, each of the plurality of chambers having an arch shaped cross section and defining an internal area, an open end of the arch shaped cross section of each of the plurality of chambers being positioned near a bottom of the defined treatment area, and being covered with a partially permeable layer, the partially permeable layer allowing a controlled release of a fluid within each of the plurality of chambers;
the treatment area inlet providing fluid flow into at least one of the plurality of chambers; and
wherein the plurality of chambers are configured to release a fluid through the partially permeable layer, causing the released fluid to pass upwardly through the medium and the root zone before exiting the defined treatment area through the outlet.

12. The linear stormwater treatment system of claim 11 further comprising a settling tank having an outlet in fluid communication with the fluid inlet.

13. The linear stormwater treatment system of claim 11 wherein the system is positioned adjacent to a parking lot, a drain of the parking lot in communication with the fluid inlet.

14. The linear stormwater treatment system of claim 11 further comprising a recycle flow, such that at least a portion of a fluid exiting the chamber is returned to the fluid inlet.

15. The linear stormwater treatment system of claim 14 wherein the recycle flow is through a pipe, the pipe containing a treatment medium, the treatment medium providing further treatment to the recycle flow.

16. The linear stormwater treatment system of claim 11 further comprising a computer controlled valve positioned on the fluid inlet, the computer controlled valve configured to allow, prevent, and control a flow through the fluid inlet, depending on a valve position.

17. The linear stormwater treatment system of claim 11 wherein the plurality of chambers are interconnected.

18. The linear stormwater treatment system of claim 11 wherein the chamber is formed as a half-pipe.

19. The linear stormwater treatment system of claim 11 wherein the fluid inlet enters each of the plurality of chambers.

20. The linear stormwater treatment system of claim 1 wherein the fluid inlet is configured to evenly distribute fluid along a length of the chamber, the fluid inlet configured as a pipe extending along the length of the chamber and having a plurality of flow outlets into the chamber.
